(19) United States
(12) Patent Application Publication
(10) Pub. No.: US 2011/0234790 A1
(43) Pub. Date: Sep. 29, 2011

(54) TIME RESOLVED PHOTOLUMINESCENCE IMAGING SYSTEMS AND METHODS FOR PHOTOVOLTAIC CELL INSPECTION

(76) Inventor: Bruce TRUE, Campbell, CA (US)

(21) Appl. No.: 13/075,125

(22) Filed: Mar. 29, 2011

Related U.S. Application Data
(60) Provisional application No. 61/318,738, filed on Mar. 29, 2010.

(51) Int. Cl. H04N 7/18

(52) U.S. Cl. 348/126; 348/E07.085

(57) ABSTRACT

A time-resolved photoluminescence technique is disclosed to image photovoltaic cells and wafers. The effective lifetime is measured directly using a photodetector that has a fast response. A pulsed light source flashes the wafer, generating excess carriers in the silicon. The rate of carrier recombination is monitored by imaging the photoluminescence decay over time. An effective lifetime can be extracted from the photoluminescence decay curve, which can be used to determine the quality of the photovoltaic cells and wafers.

### CROSS-REFERENCE TO RELATED PATENT APPLICATION

This application claims the benefit of the Provisional Application No. 61/318,738, filed on Mar. 29, 2010, the disclosure of which is hereby incorporated herein in its entirety by reference.

### BACKGROUND

1. Field

The subject invention relates to time resolved photoluminescence imaging systems and methods for photovoltaic cell inspection.

2. Related Art

Photoluminescence is the re-emission of light after absorbing light of a higher energy (shorter wavelength). Visible light from a solar lamp, laser, or LED excites electrons in photovoltaic wafer materials such as silicon. Most of the photo-generated electrons give up their energy as heat, but a small fraction of the electrons recombine with holes in the silicon, emitting a photon (radiative recombination). More defects in the silicon result in more energy lost as heat and fewer emitted photons, while fewer defects in the silicon result in more radiative recombination and more emitted photons.

Photoluminescence has not been used frequently as an imaging technique of photovoltaic cells because existing imaging detectors, such as a complementary metal oxide semiconductor (CMOS) or charge-coupled device (CCD), have several disadvantages. For example, the existing imagers can collect only a tiny fraction of the entire range of the luminescence signal. These existing photoluminescence detectors continuously illuminate the wafer material with light, use a filter to block that light, and collect the weak photoluminescence glow coming from the wafer. If the light intensity is too high, the image does not have a high resolution because the high intensity light tends to blur the details. The only way to collect high resolution photoluminescence images is to reduce the light intensity. This however, requires an exposure of at least a few seconds and more typically a minute or more to collect the image. This technique however is not suited to in-line measurements and becomes a bottleneck in the process.

InGaAs focal plane arrays can also collect photoluminescence images, but the high noise floor requires very high illumination levels to achieve even a minimal signal. The high light levels tend to wash out the fine details, and require a cooling system for the cell under test. The detector itself also requires significant cooling to keep the inherent dark current from overwhelming the much weaker luminescence.

Existing steady-state photoluminescence signal techniques are disadvantageous because they require calibration to convert the signal into an effective lifetime. Because the photoluminescence intensity is proportional to the dopant intensity, the dopant density must be taken into account during the calibration (e.g., measured from resistivity and thickness). Calibration of intensity to lifetime is determined by measuring the lifetime of “golden” wafers using u-PCD or equivalent techniques, capturing the photolumincent intensity of the “golden” wafers, creating a calibration curve, verifying the calibration curve accuracy and refining the curve and programming it into software. In addition, photoluminescence intensity is dependent on the absorption of excitation ight which can be affected by surface reflectivity and roughness.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a system is provided that includes an imaging inspection module to generate a time-resolved photoluminescence image of a silicon wafer; and a plurality of processing modules to process the silicon wafer into a photovoltaic cell.

The imaging inspection module may include a pulsed light source and a camera. The imaging inspection module may further include a wafer sensor and a controller in communication with the pulsed light source and the camera.

The plurality of processing modules may be selected from the group consisting of etch, diffusion, wet etch, passivation and ARC, screen print, firing and combinations thereof.

The imaging inspection module may be a first imaging inspection module, and the system may further include a second imaging inspection module between two of the plurality of processing modules.

According to another aspect of the invention, an inspection module is provided that includes a pulsed light source to cause photoluminescence in a wafer; a camera comprising an electron bombarded active pixel sensor to capture photoluminescence exposure data from the wafer; and a computer to generate a time-resolved photoluminescence decay curve from the photoluminescence exposure data.

The inspection module may also include a wafer sensor and a controller in communication with the pulsed light source and the camera. The camera may be configured to detect luminescence wavelengths of at least about 950 nm to at least about 1250 nm. The camera may include a InGaAsP focal array.

According to a further aspect of the invention, a method is provided that includes pulsing light at a wafer to cause photoluminescence; capturing first photoluminescence exposure data at a first time; capturing second photoluminescence exposure data at a second time, the second time being after the first time; capturing third photoluminescence exposure data at a third time, the third time being after the second time; and combining the first, second and third photoluminescence exposure data to generate a photoluminescence decay curve of the wafer.

The method may also include capturing fourth photoluminescence exposure data at a fourth time, the fourth time being after the third time, and the combining may include combining the first, second, third and fourth photoluminescence exposure data to generate a photoluminescence decay curve of the wafer.

The method may also include capturing fifth photoluminescence exposure data at a fifth time, the fifth time being after the fourth time, and combining may include combining the first, second, third, fourth and fifth photoluminescence exposure data to generate a photoluminescence decay curve of the wafer.

Pulsing the light comprises pulsing the light a first time, and the method may also include pulsing the light a second time at the wafer to cause photoluminescence.

The method may also include capturing fourth photoluminescence exposure data at the first time; capturing fifth photoluminescence exposure data at the second time; capturing sixth photoluminescence exposure data at the third time; combining the first photoluminescence exposure data and fourth photoluminescence exposure data at the first time to generate a first photoluminescence image at the first time; combining the second photoluminescence exposure data and fifth photoluminescence exposure data at the second time to generate a second photoluminescence image; combining the third photoluminescence exposure data and sixth photoluminescence exposure data at the third time to generate a third photoluminescence image; and combining the first, second and third photoluminescence images of the wafer to generate the photoluminescence decay curve of the wafer.

The method may also include sensing the wafer prior to pulsing the light.

The method may also include determining the carrier lifetime of the wafer based on the photoluminescence decay curve.

The wafer may be a photovoltaic cell. The wafer may include silicon.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a photovoltaic cell;

FIG. 2A is a graph showing a laser pulse and a photoluminescence decay curve for an exemplary photovoltaic cell;

FIG. 2B is a graph showing a normalized view of the photoluminescence day of FIG. 2A;

FIG. 2C is a graph showing an intensity plot of an exposure sequence collected according to one embodiment of the invention;

FIG. 3 is a block diagram of a photovoltaic cell inspection device in accordance with one embodiment of the invention;

FIG. 4 is a schematic diagram of the photovoltaic cell inspection device of FIG. 3 in accordance with one embodiment of the invention;

FIGS. 5 is a detailed schematic view of a camera in accordance with one embodiment of the invention;

FIG. 6 is a graph showing the photoluminescence spectrum for silicon, the sensitivity of a prior art sensor, and the sensitivity of the camera in accordance with one embodiment of the invention;

FIG. 7 is a flow diagram showing a time-resolved photoluminescence method in accordance with one embodiment of the invention;

FIGS. 7A and 7B are schematic diagrams illustrating the method of FIG. 7 in accordance with one embodiment of the invention;

FIGS. 8 is a schematic diagram illustrating a lifetime that is shorter than a light pulse in accordance with one embodiment of the invention;

FIGS. 9A and 9B are schematic diagrams illustrating the method of FIG. 7 in which the decay curve is generated for a wafer having a lifetime shorter than the light pulse in accordance with one embodiment of the invention;

FIG. 10 is a schematic diagram showing inspection of a photovoltaic cell in accordance with one embodiment of the invention;

FIG. 11 is a schematic diagram of a photovoltaic cell processing system in accordance with one embodiment of the invention; and

FIG. 12 is a block diagram of an exemplary computer system in accordance with one embodiment of the invention.

### DETAILED DESCRIPTION

A time-resolved photoluminescence technique is disclosed for imaging and inspecting photovoltaic cells. Photoluminescence intensity is directly proportional to carrier lifetime: −I_{PL}=c Δn=cT, where n is the carrier charge density, c is a constant and T is the lifetime. A pulsed light source flashes the wafer, generating excess carriers in the silicon, causing photoluminescence. The rate of carrier recombination is monitored by imaging the photoluminescence decay over time using a photodetector that has a fast response. A photoluminescence decay curve is generated, and the effective lifetime is extracted from the curve. As a result, the effective lifetime is measured directly.

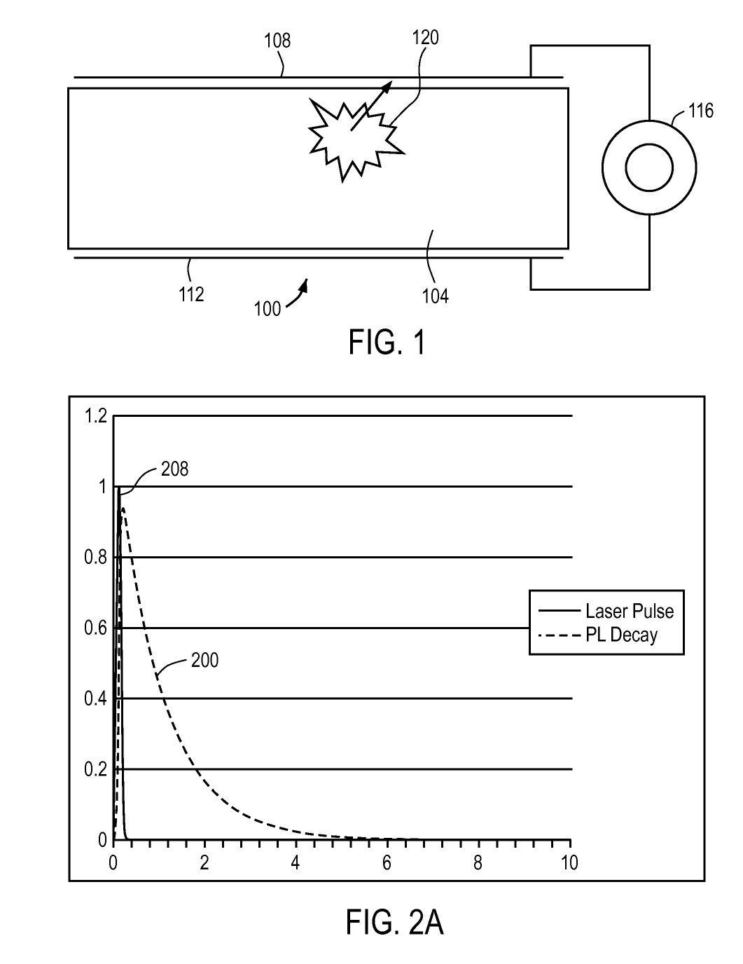

An embodiment of the invention will now be described in detail with reference to FIG. 1. FIG. 1 illustrates an exemplary photovoltaic cell 100. The photovoltaic cell typically includes a semiconductor wafer 104 that converts energy from sunlight into electrical energy. The semiconductor wafer 104 is typically silicon but it will be appreciated that other materials may be used. Metal contacts 108, 112 (anode/cathode leads) are provided at either end of the semiconductor wafer 104 to collect the electrical energy 120. A current source 116 may also be provided.

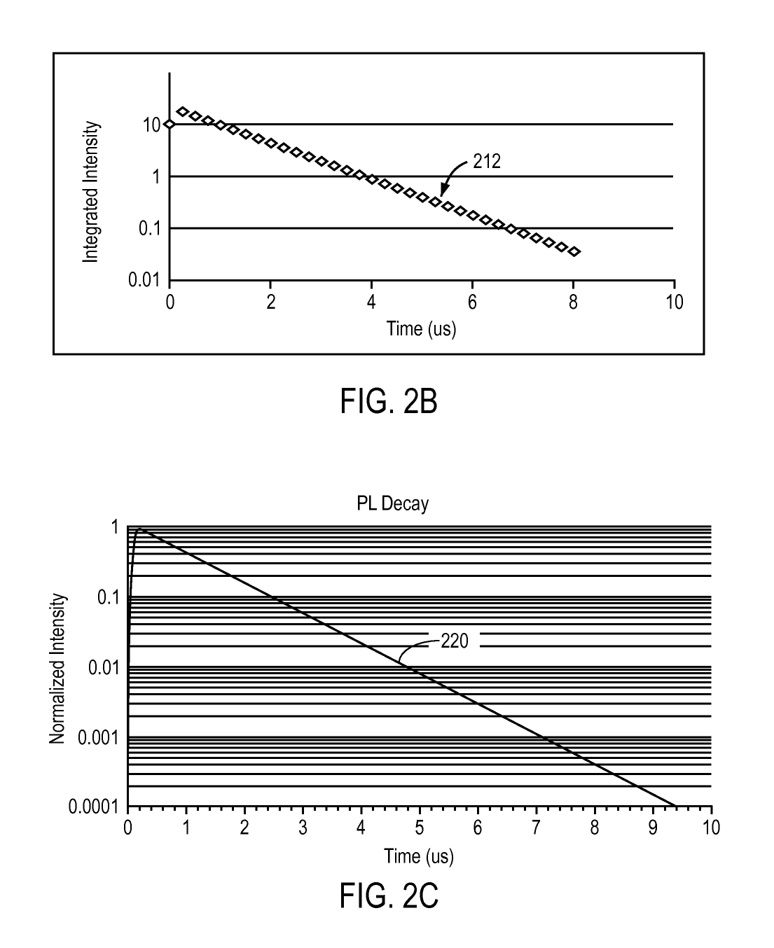

FIG. 2A is a graph showing a photoluminescence decay curve 200 of an exemplary silicon wafer following a laser pulse 208. As shown in FIG. 2A, the laser pulse is much shorter than the lifetime (i.e., about 50 ns for the laser pulse compared to about 1 μs for the lifetime of the photoluminescence). FIG. 2B is an intensity plot of an exemplary exposure sequence for the photoluminescence decay curve 200 of FIG. 2A. The slope of the line 212 shown in FIG. 2B reveals that the lifetime is about 1 μs. The line 212 of FIG. 2B was captured with a camera collecting a sequence of 200 ns exposures every 250 ns. FIG. 2C illustrates a line 220 fit to the log of the photoluminescence decay exposure sequence of FIG. 2B. The slope of the line 220 of FIG. 2C is equal to the reciprocal of the lifetime.

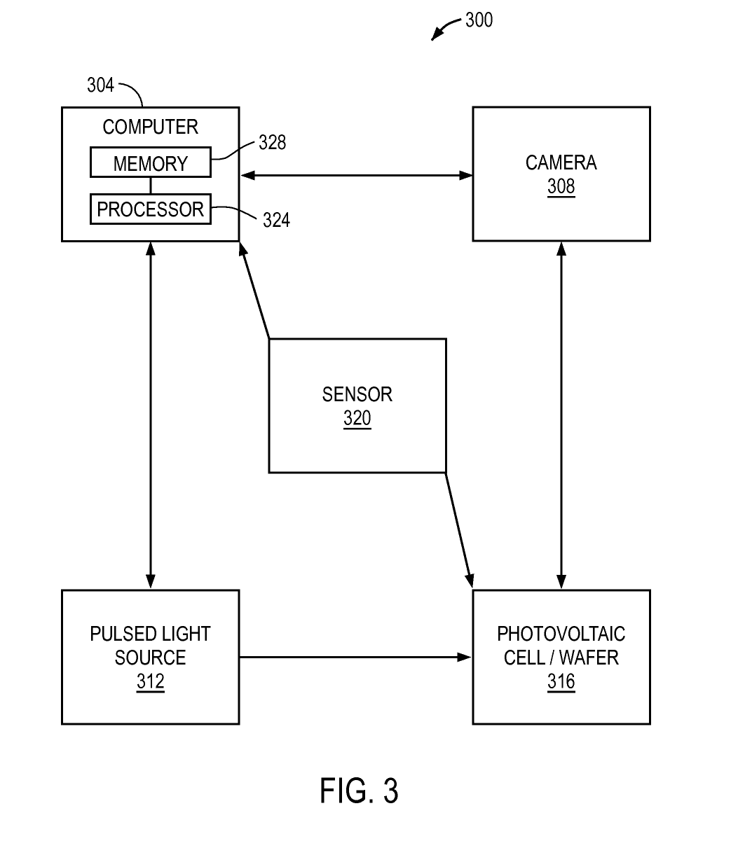

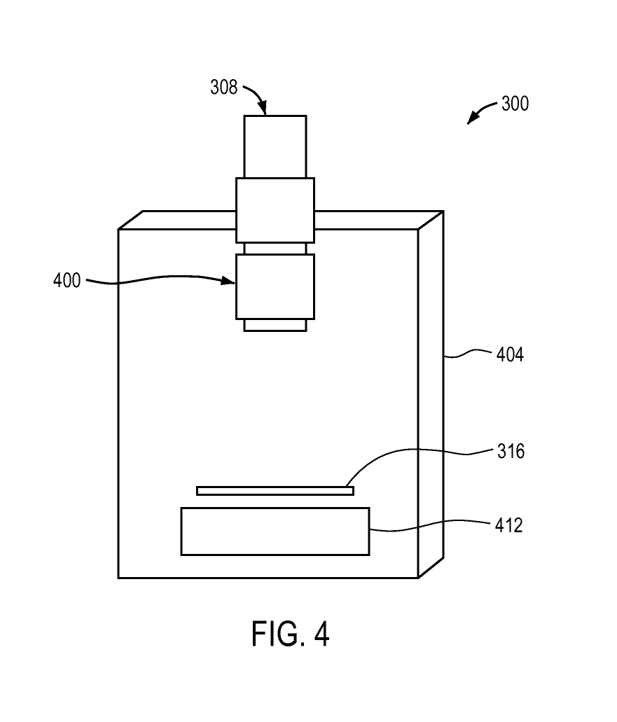

FIG. 3 illustrates an inspection system 300 according to one embodiment of the invention. The inspection system 300 includes a controller 304, a camera 308, a pulsed light source 312 and a photovoltaic cell or wafer 316. The system 300 may also include a wafer sensor 320. As shown in FIG. 4, the system 300 may also include high-efficiency optics 400, an enclosure 404 and a support 412 for the device under test 316. Referring back to FIG. 3, the controller 304 may include a processor 324 and memory 328. The controller 304 may include timing circuitry. The camera 308 is used in conjunction with the pulsed light source 312 to directly monitor the photoluminescence decay of the photovoltaic cell 316.

In one embodiment, the support 412 is an electrostatic chuck. In other embodiments, the support 412 is a conveyor. In one embodiment, the inspection system 300 is designed to image a 10×10 cm or 15×15 cm photovoltaic cell 316 at a distance of about 50-75 cm (i.e., the distance between the support 412 and the camera 308 is about 50-75 cm).

The camera 308 captures photoluminescence images from the photovoltaic cells undergoing inspection in the system 300. The camera 308 may be optimized to capture these photoluminescence images and may be optimized to capture images from particular types of photovoltaic cells (e.g., silicon photovoltaic cells). The camera 308 is characterized in that it is sensitive to low light, it can be turned on/off quickly (e.g., every 1-2 μs) and that it is sensitive to the wavelength for silicon luminescence (e.g., at least about 950 nm-1250 nm).

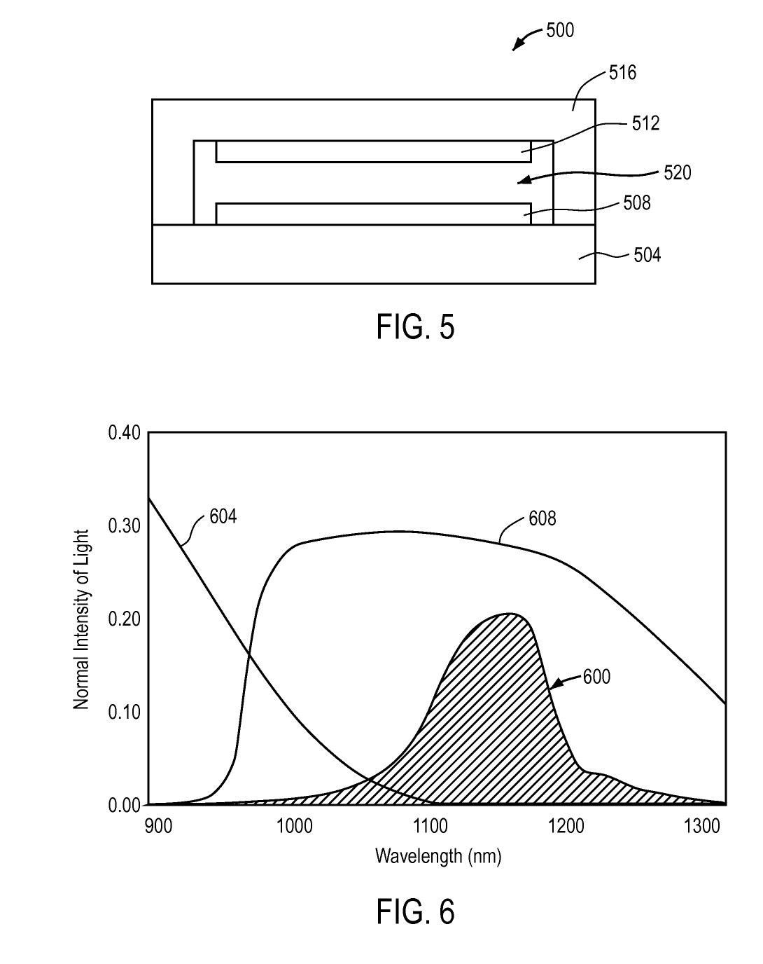

In one embodiment, the camera 308 is an electron bombarded active pixel sensor (EBAPS). An exemplary camera having an EBAPS sensor is disclosed in U.S. Pat. No. 6,657,178, the entirety of which is hereby incorporated by reference. A detailed view of the EBAPS sensor is shown in FIG. 5. As shown in FIG. 5, the EBAPS sensor 500 includes a faceplate 504, a photocathode 508, a CCD or CMOS 512 (which may be a back-illuminated CCD/CMOS) and a package 516. A vacuum 520 is formed between the photocathode 508 and the CCD/CMOS anode 512. In use, photons formed by the photocathode 508 create electrons, which are emitted by the photocathode and accelerated by high voltage. The accelerated electron impacts the CCD/CMOS anode 512. The electron slows down in the anode 512 creating many secondary electrons. The primary electron and the cloud of secondary electrons are recorded and measured by the CCD/CMOS anode 512.

In one particular embodiment, the camera 308 is an electron bombarded, back-illuminated 1.3 MegaPixel CMOS camera, which can capture 30 frames per second. In one embodiment, the EBCMOS camera uses a InGaAsP focal array, which reduces the inherent dark current by more than a hundred-fold, and has a much lower read noise, compared to a InGaAs focal plane array camera. The camera 308 may also have electron bombarded gain to magnify the signal of every photon.

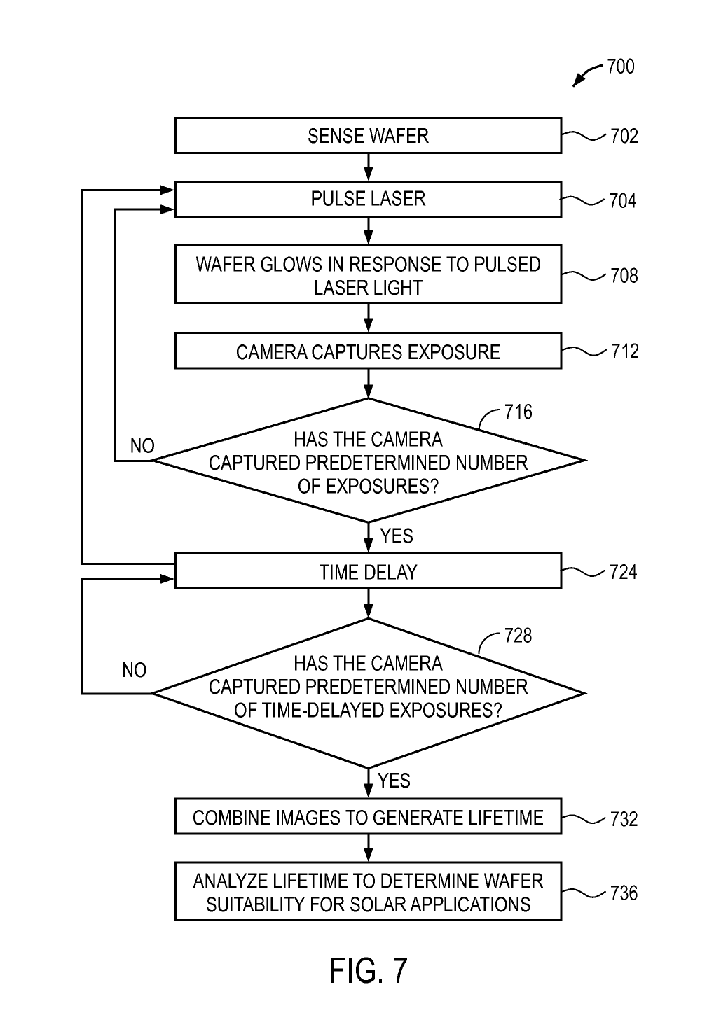

FIG. 6 is a graph showing the photoluminescence spectrum for silicon 600 (i.e., about 950 nm-1250 nm, with a peak at about 1150 nm), the sensitivity of a prior art sensor 604, and the sensitivity of the camera in accordance with one embodiment of the invention 608. As shown in FIG. 6, the camera 308, as evidenced by line 608, is able to collect the full intensity coverage of the photoluminescence spectrum as shown by line 600, whereas the traditional silicon sensor sensitivity, shown by line 604, has less than 1% coverage.

With reference back to FIG. 3, the pulsed light source 312 generates light that causes photoluminescence in the photovoltaic cell 316. In one embodiment, the pulsed light source 312 is a pulsed LED or a flash lamp. In one embodiment, the light source 312 is capable of being turned on/off at any value or range of values less than about 100 ns, and the time between pulses is about 100 Hz to 5 kHz. It will be appreciated that the pulsed light source 312 is configured to direct light toward the photovoltaic cell/wafer 316 that is not only visible light, but also includes infrared and ultraviolet light.

A pulse is used that is much shorter than the lifetime of the photovoltaic cell 316. This allows the camera 308 to image the wafer 316 at several points in time along the photoluminescence decay. The camera 308 captures exposures that are of the same order or shorter than the lifetime of the material under study. (The minority carrier lifetime of silicon can vary from a little less than 1, μs to several ms.) Thus, the camera 308 should be able to accumulate exposures at about the same rate as the light pulses (e.g., about 100 Hz to 5 kHz).

In use, the photovoltaic cell or wafer 316 is positioned in the camera's field of view. In one embodiment, sensor 320 is used to detect when the cell/wafer 316 is positioned in the camera's filed of view. A trigger signal may be sent by the controller 304 to the camera 308 and pulsed light source 312 when the controller 304 receives a signal from the sensor 320 that the cell/wafer 316 is in position.

The pulsed light source then flashes to illuminate the cell/wafer 316 for a few microseconds while it is under the field of view of the camera 308. The short burst of light illuminates the wafer 316, and the photoluminescence glow goes from bright and blurry to dim and crisp in microseconds. After a suitable time delay, the camera's internal timing generator sends a second trigger pulse to gate the photocathode and capture the photoluminescence from the wafer 316. The camera 308 captures the crisp dim glow that lasts for tens to hundreds of microseconds. The light pulse, and delayed exposure take place in under a millisecond. Reading out the image takes 33 ms, and the whole process can easily be done at least 20 times a second.

The image recorded by the camera 308 is then sent to a computer (controller 304 or another computer in communication with the camera 308) for image analysis. This information can then be fed back into the process control system, and the process can be repeated several times to collect the exposure data (e.g., as shown in FIG. 2B) after multiple time delays and after multiple pulses.

The computer can then fit a line to the exposure data to generate the photoluminesce decay curve (e.g., as shown in FIG. 2C). In one embodiment, the computer may combine exposure data following multiple pulses to generate an image for each time delay. The computer may also calculate the slope of the curve to calculate the effective lifetime.

The computer may display the photovoltaic curve and lifetime information and also provide information on the cell/wafer 316 such as overall efficiency, uniformity, dark defects, etc. The computer may also display the images of the photovoltaic cell/wafer 316. This information can then used to accept/reject cells/wafers 316, and to bin them so that solar panels can be manufactured with a consistent efficiency rating. The computer may also use the lifetime information to provide process monitoring and/or cell/wafer grading.

It will be appreciated that it is also possible to extract the lifetime if the laser pulse width and camera exposure time are of the same order as the photoluminescence lifetime. In this case, Least Squares Iterative Reconvolution can be used to determine the photoluminescence lifetime. The measured decay profile is the convolution of the laser pulse, the camera exposure profile, and the photoluminescence lifetime. The laser pulse and camera exposure profile can be measured, and then convolved with various lifetimes until the lifetime that generates the decay profile closest to the measured one is found.

It will also be appreciated that the inspection module 300 may be combined with other known inspection technologies to collect additional information about the photovoltaic cell/wafer 316.

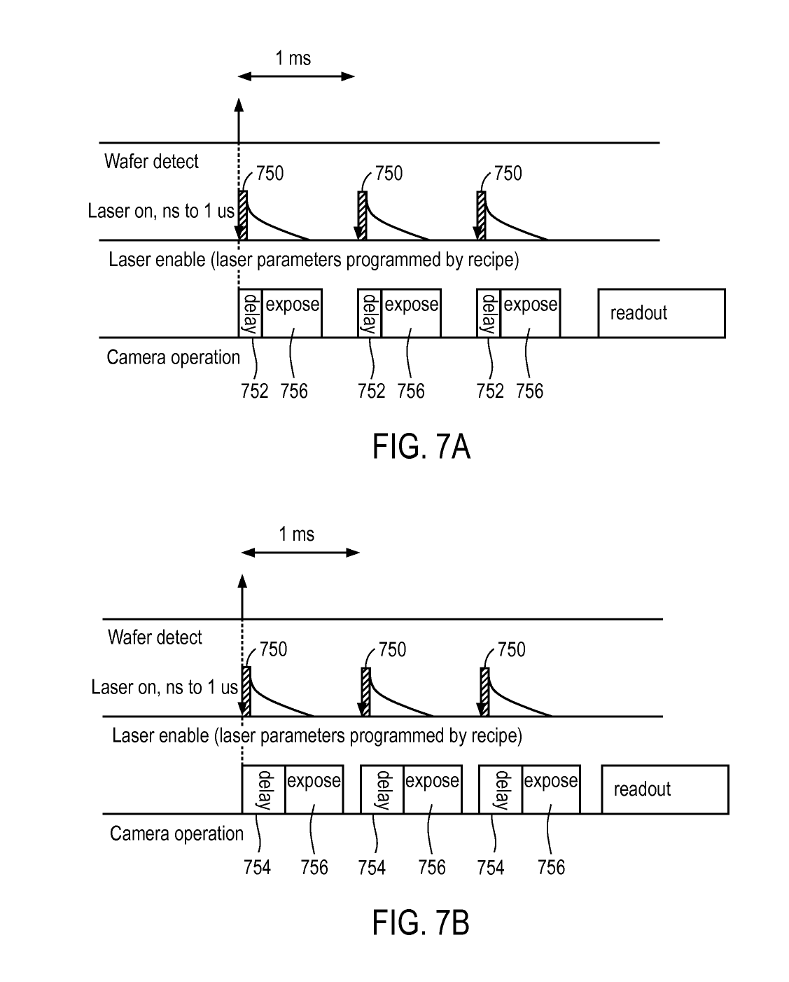

FIG. 7 is a flow diagram showing the time-resolved process for determining photoluminescence lifetime according to one embodiment of the invention. It will be appreciated that the process 700 described below is merely exemplary and may include a fewer or greater number of steps, and that the order of at least some of the steps may vary from that described below.

As shown in FIG. 7, the process 700 may begin by sensing the wafer (or cell) 702. For example, sensor 320 may sense that the wafer/cell 316 is in position under the camera 308, and may send a signal to the controller 304.

The light source is pulsed (block 704) to illuminate the wafer, which causes the wafer to glow (block 708). For example, the control 304 may send a trigger signal 304 to the pulsed light source 312 to pulse light toward the wafer/cell 316.

The camera then captures an exposure (block 712). For example, the camera 308 captures the photoluminescence data as an exposure as described above. This process may be repeated several times by generating multiple light pulses, and capturing the exposure data following each light pulse to generate sufficient exposures to generate an image at a particular time. Once sufficient exposure data is captured (block 716), a time delay then occurs (block 724), and the process repeats itself again. For example, the light source may be pulsed one or more times, and the camera captures the exposure data as described above. The process repeats again following multiple time delays until sufficient exposure data to generate the photoluminescence decay curve. In one embodiment, any value or range of values between about 5 time delays and about 50 time delays occur to generate the photoluminescence decay curve. It will be appreciated that fewer than 5 time delays or more than 50 time delays may occur. In one embodiment, the time delays may differ by a few nanoseconds or by a few microseconds, and in one embodiment, the time delays may occur at any value or range of values between about 10 ns to about 200 μs. It will be appreciated that the time delay may be less than 10 ns or greater than 200 μs. In one embodiment, the process repeats any values or range of values between about ten times and about 2,000 times. It will be appreciated that the process may repeat itself less than ten times or more than 2,000 times. In one embodiment, the number of times the exposure data is captured for a given time delay varies. For example, when the signal is strong, at the beginning of the decay curve, the process may be repeated about 10 to about 100 times, but when the signal is weaker, the process may repeated about 100 to about 2000 times. It will be appreciated that by collecting exposures at each data point or time delay, the signal to noise ratio is improved.

For example, FIGS. 7A and 7B illustrate capturing multiple exposures for multiple pulses 750 as described above. In FIG. 7B, the time delay 754 is greater than the time delay 752 prior to the camera exposure 756. As shown in FIGS. 7A and 7B, an exemplary time between pulses is less than 1 ms.

Referring back to FIG. 7, once the camera has captured enough exposures to generate the photoluminescence decay curve (block 728), the exposures are combined into images at the computer and the photoluminescence decay curve is generated based on the different images at the various time delays (block 732). The photoluminescence decay curve can be used to determine the lifetime of the wafer as described above (block 736).

The lifetime can then be used to accept/reject the wafer. In one embodiment, the computer determines whether the wafer is acceptable. In another embodiment, the computer outputs the lifetime to a display, and a human operator determines whether the wafer is acceptable.

Because the measurement of the decay curve is direct, no calibration is required. Data collection occurs in a few seconds and the result is a high resolution of the wafer/cell lifetime. The lifetime image is independent of the photoluminescence intensity, and there are no absorption or reflection effects.

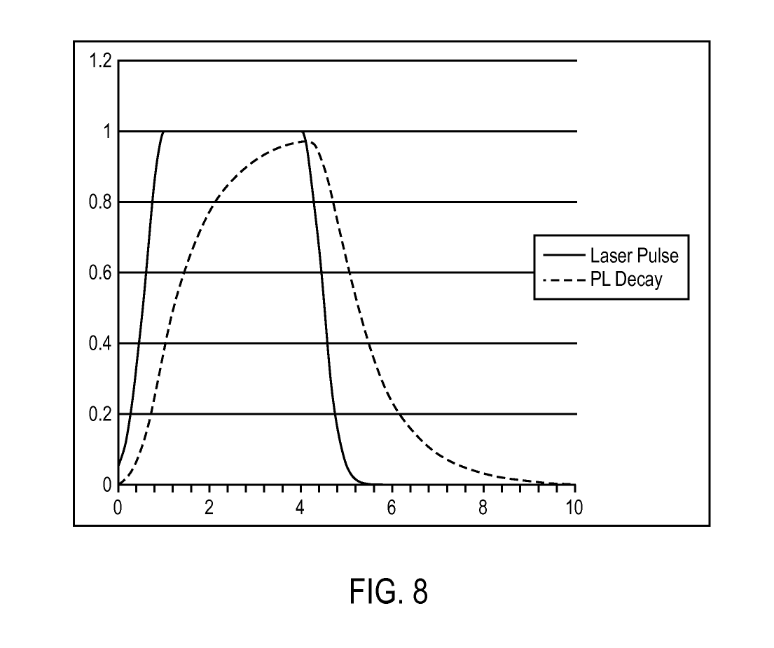

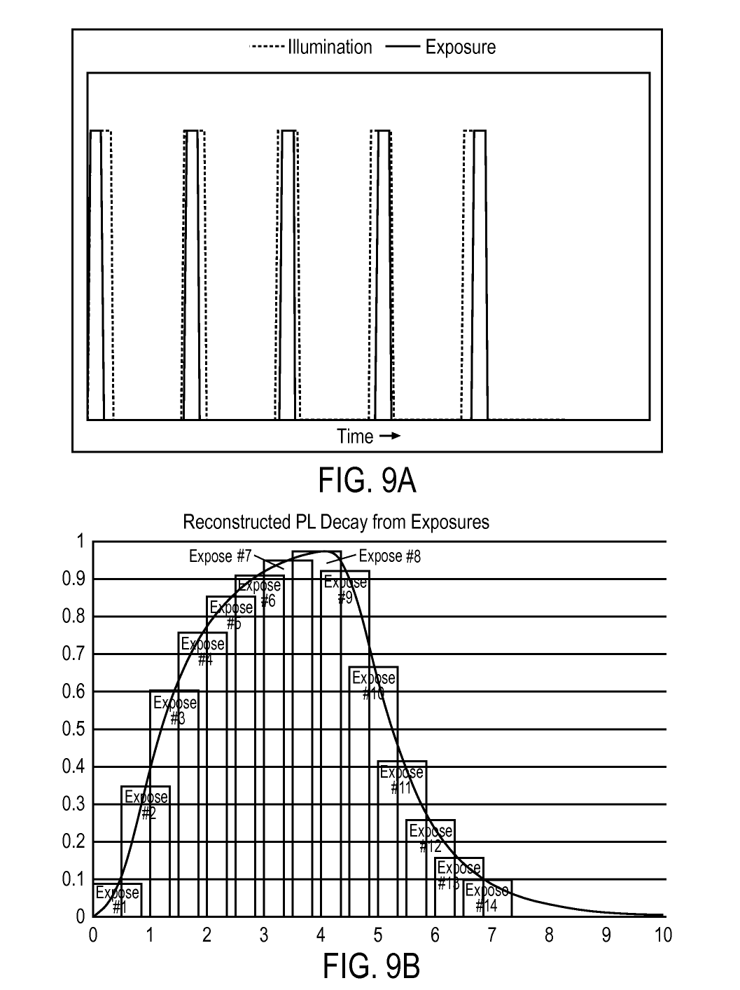

There are cases where the lifetime of the sample is shorter than the pulse time of the illumination source or the minimum exposure time of the imager, as shown in FIG. 8. It is still possible to extract the correct lifetime from a photoluminescence decay that is shorter than the illumination pulse if the delay between illumination and exposure can be more finely controlled than the lifetime. EBAPS cameras are advantageous for this embodiment because they have an intrinsic filter and do not respond to short wavelength light so that overlapping illumination and exposure can be performed. Thus, the light source 312 and camera 308 can operate at the same time. As shown in FIG. 9A, a pulse chain, in which the exposures overlap in time relative to the illumination pulse, is used to generate the photoluminesce decay curve. In the pulse chain shown in FIG. 9A, a single exposure at a given delay time is shown, but there could be tens to thousands of exposure at a particular delay time to accumulate a useful image. An exemplary decay curve constructed from overlapping exposures is shown in FIG. 9B. Statistical methods, such as least squares iterative reconvolution or method of moments may be used to extract the photoluminescence lifetime from the measured decay curve shown in FIG. 9B.

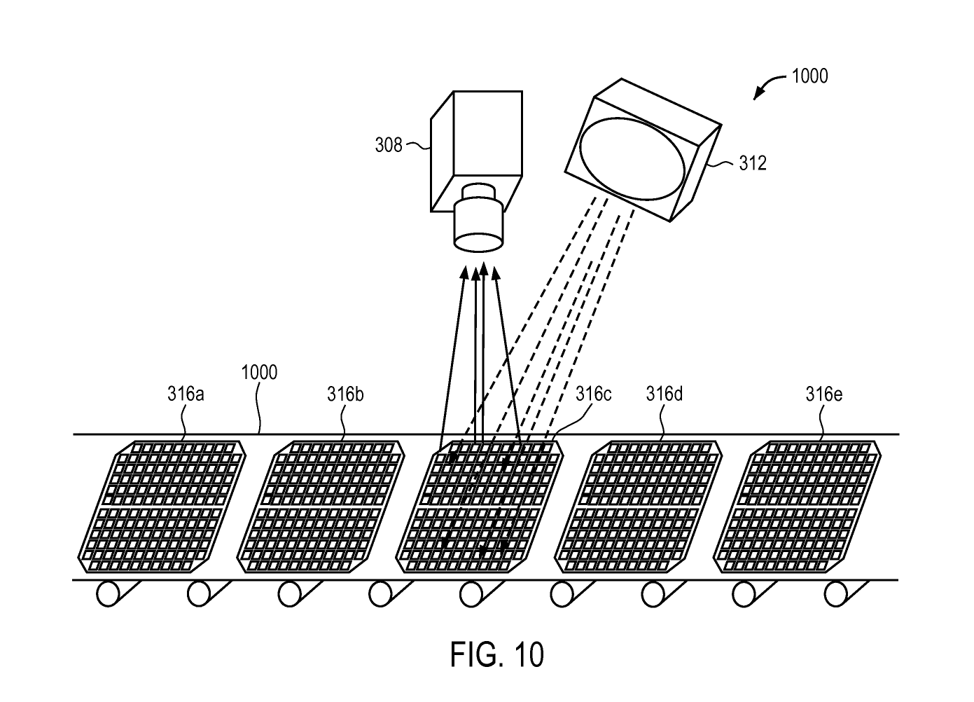

FIG. 10 illustrates a schematic view of an inspection system 1000 showing the inspection system 300 with a conveyor 1000. As shown in FIG. 10, multiple photovoltaic cells 316a-e are fed under the camera 308 and pulsed light source 312 on the conveyor 1000. Since pulsed photoluminescence uses strobed illumination, the conveyor belt never needs to stop. The limiting factor on the maximum throughput is no longer the imaging subsystem but the ability of the system to physically handle and transport the wafers, which allows the inspection system to be used in an in-line process monitoring system.

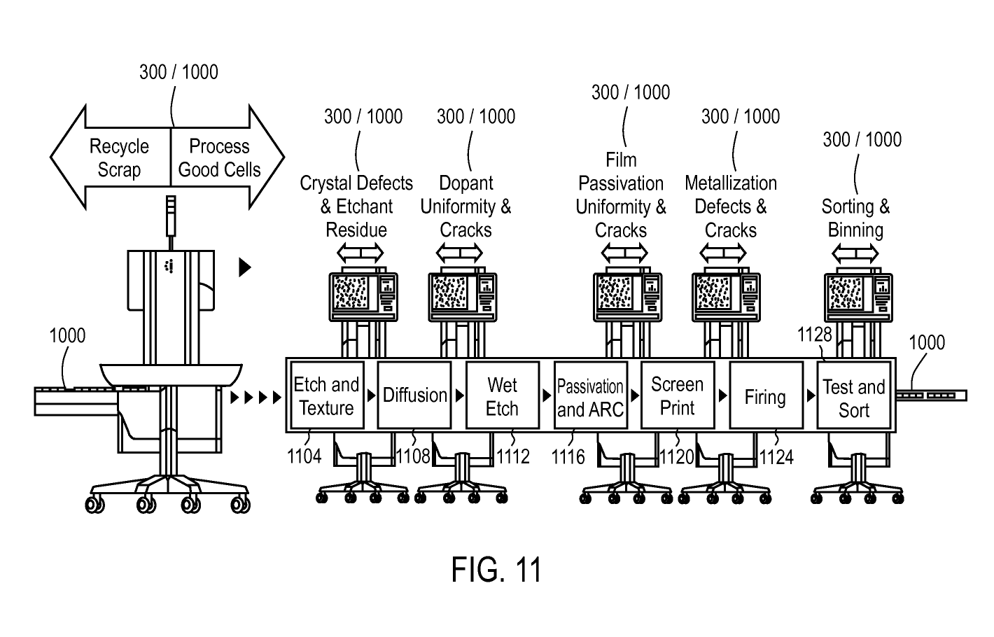

FIG. 11 illustrates an exemplary in-line process monitoring system 1100. As shown in FIG. 11, the monitor can be placed anywhere in the process line without increasing the wafer processing time because the material handling is the rate limiting step (the imaging is no longer the rate limiting step).

In the exemplary in-line processing system 1100, the system 1100 includes the inspection system 300/1000, an etch and texture module 1104, a diffusion module 1108, a wet etch module 1112, a passivation and ARC module 1116, a screen print module 1120, a firing module 1124 and a test and sort module 1128. In one embodiment, a conveyor 1000 feeds the wafers/photovoltaic cells through the in-line processing system 1100 from the inspection module 300/1000 through the test and sort module 1128.

As shown in FIG. 11, the inspection system module 300/1000 may be placed at the beginning of the process, between the etch and texture module 1104 and the diffusion module 1108 to examine crystal defects and etchant residue, between the diffusion module 1108 and the wet etch module 1112 to monitor dopant uniformity and cracks, between the passivation and ARC module 1116 and the screen print module 1120 to monitor film passivation uniformity and cracks, between the screen print 1120 module and the firing module 1124 to monitor metallization defects and cracks, and as the test and sort module 1128 for sorting and binning. This allows wafers to be removed before processing begins and to remove defective wafers from the line, which enables a rapid shift in cell efficiency through in-line inspection and avoids misprocessing. In one embodiment, photoluminescence images of in-process material and finished cells can be collected at 3600 wafers per hour. Advantages include increased yield, improved cell efficiency through tighter process control and reduced processing costs.

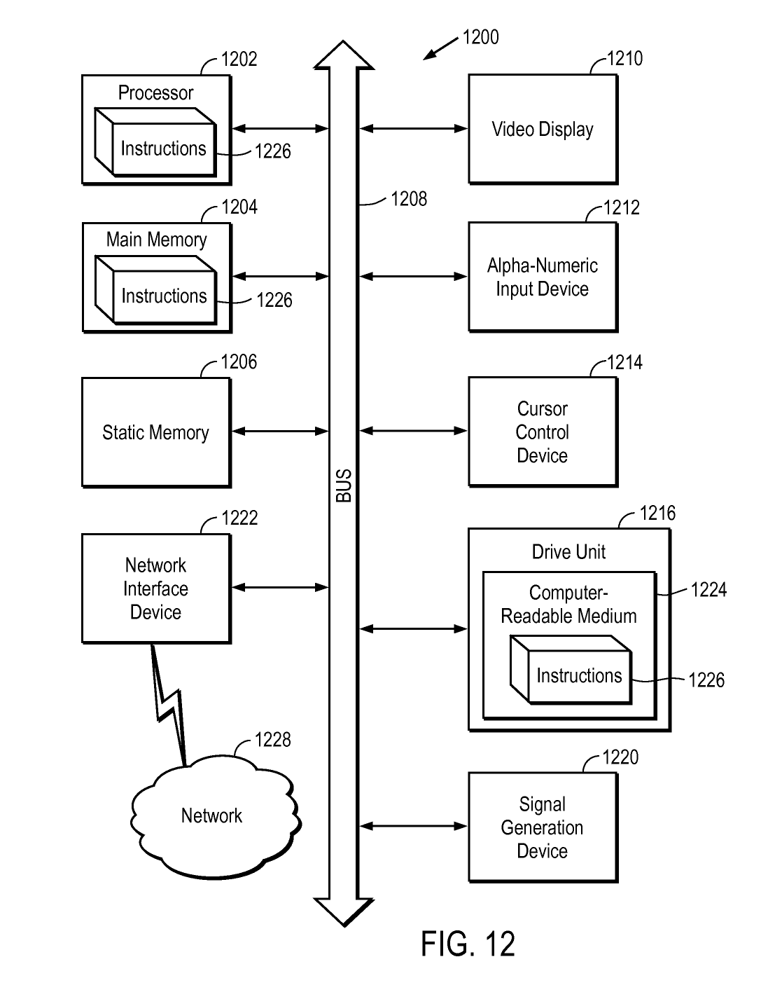

FIG. 12 shows a diagrammatic representation of machine in the exemplary form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server, a personal computer (PC), a tablet PC, a set-top box (STB), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU), a graphics processing unit (GPU) or both), a main memory 1204 (e.g., read only memory (ROM), flash memory, dynamic random access memory (DRAM) such as synchronous DRAM (SDRAM) or Rambus DRAM (RDRAM), etc.) and a static memory 1206 (e.g., flash memory, static random access memory (SRAM), etc.), which communicate with each other via a bus 1208.

The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1220 (e.g., a speaker) and a network interface device 1222.

The disk drive unit 1216 includes a computer-readable medium 1224 on which is stored one or more sets of instructions (e.g., software 1226) embodying any one or more of the methodologies or functions described herein. The software 1226 may also reside, completely or at least partially, within the main memory 1204 and/or within the processor 1202 during execution thereof by the computer system 1200, the main memory 1204 and the processor 1202 also constituting computer-readable media. The software 1226 may further be transmitted or received over a network 1228 via the network interface device 1222.

While the computer-readable medium 1224 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any tangible medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the computer is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It should be understood that processes and techniques described herein are not inherently related to any particular apparatus and may be implemented by any suitable combination of components. The present invention has been described in relation to particular examples, which are intended in all respects to be illustrative rather than restrictive. Those skilled in the art will appreciate that many different combinations will be suitable for practicing the present invention. It is intended that the specification and examples be considered as exemplary only, with a true scope and spirit of the invention being indicated by the following claims.

What is claimed is:

1. A system comprising:
an imaging inspection module to generate a time-resolved photoluminescence image of a silicon wafer, the imaging inspection module comprising a pulsed light source and an electron bombarded active pixel sensor; and
a plurality of processing modules to process the silicon wafer into a photovoltaic cell.

2. The system of claim 1, wherein the imaging inspection module further comprises a wafer sensor and a controller in communication with the pulsed light source and the camera.

3. The system of claim 1, wherein the plurality of processing modules are selected from the group consisting of etch, diffusion, wet etch, passivation and ARC, screen print, firing and combinations thereof.

4. The system of claim 1, wherein the imaging inspection module is a first imaging inspection module, and wherein the system further comprises a second imaging inspection module between two of the plurality of processing modules.

5. An inspection module comprising:
a pulsed light source to cause photoluminescence in a wafer;
a camera comprising an electron bombarded active pixel sensor to capture photoluminescence exposure data from the wafer; and
a computer to generate a time-resolved photoluminescence decay curve from the photoluminescence exposure data.

6. The inspection module of claim 5, further comprising a wafer sensor and a controller in communication with the pulsed light source and the camera.

7. The inspection module of claim 5, wherein the wafer is a photovoltaic cell.

8. The inspection module of claim 5, wherein the wafer comprises silicon.

9. The inspection module of claim 5, wherein the camera is configured to detect luminescence wavelengths of at least about 950 nm to at least about 1250 nm.

10. The inspection module of claim 5, wherein the camera comprises a InGaAsP focal array.

11. A method comprising:
directing a first light pulse at a wafer to cause photoluminescence;
capturing first photoluminescence exposure data at a first time;
capturing second photoluminescence exposure data at a second time, the second time being after the first time;
capturing third photoluminescence exposure data at a third time, the third time being after the second time;
directing a second light pulse at the wafer to cause photoluminescence;
capturing fourth photoluminescence exposure data at the first time;
capturing fifth photoluminescence exposure data at the second time;
capturing sixth photoluminescence exposure data at the third time;
combining the first photoluminescence exposure data and fourth photoluminescence exposure data at the first time to generate a first photoluminescence image at the first time;
combining the second photoluminescence exposure data and fifth photoluminescence exposure data at the second time to generate a second photoluminescence image;
combining the third photoluminescence exposure data and sixth photoluminescence exposure data at the third time to generate a third photoluminescence image; and
combining the first, second and third photoluminescence images of the wafer to generate the photoluminescence decay curve of the wafer.

12. The method of claim 11, further comprising capturing fourth photoluminescence exposure data at a fourth time, the fourth time being after the third time, and wherein the combining comprises combining the first, second, third and fourth photoluminescence exposure data to generate a photoluminescence decay curve of the wafer.

13. The method of claim 11, further comprising capturing fifth photoluminescence exposure data at a fifth time, the fifth time being after the fourth time, and wherein the combining comprises combining the first, second, third, fourth and fifth photoluminescence exposure data to generate a photoluminescence decay curve of the wafer.

14. The method of claim 11, further comprising sensing the wafer prior to pulsing the light.

15. The method of claim 11, further comprising determining the carrier lifetime of the wafer based on the photoluminescence decay curve.

16. A method comprising:
pulsing light at a wafer to cause photoluminescence;
capturing first photoluminescence exposure data at a first time;
capturing second photoluminescence exposure data at a second time, the second time being after the first time;
capturing third photoluminescence exposure data at a third time, the third time being after the second time, wherein capturing the second photoluminescence exposure data overlaps with at least one of capturing the first photoluminescence exposure data and capturing the third photoluminescence exposure data; and
combining the first, second and third photoluminescence exposure data to generate a photoluminescence decay curve of the wafer.

17. The method of claim 16, further comprising sensing the wafer prior to pulsing the light.

18. The method of claim 16, further comprising determining the carrier lifetime of the wafer based on the photoluminescence decay curve.

19. A method comprising:
directing a first plurality of light pulses at a wafer to cause photoluminescence;
capturing photoluminescence exposure data after a first time delay for each of the first plurality of light pulses;
directing a second plurality of light pulses at a wafer to cause photoluminescence;
capturing photoluminescence exposure data after a second time delay for each of the second plurality of light pulses, the second time delay being different than the first time delay;
directing a third plurality of light pulses at a wafer to cause photoluminescence;
capturing photoluminescence exposure data after a third time delay for each of the third plurality of light pulses, the third time delay being different than the first time delay and the second time delay; and
generating a photoluminescence decay curve of the wafer from the photoluminescence exposure data.

20. The method of claim 19, further comprising sensing the wafer prior to pulsing the light.

21. The method of claim 19, further comprising determining the carrier lifetime of the wafer based on the photoluminescence decay curve.
